(19) United States
(12) Patent Application Publication
(10) Pub. No.: US 2017/0192503 A1
(43) Pub. Date: Jul. 6, 2017

(54) Electronic Device and Method for Displaying Focal Region via Display Unit for Control

(71) Applicant: Lenovo (Beijing) Limited, Beijing (CN)

(72) Inventors: Chen Chen, Beijing (CN); Haisheng Dai, Beijing (CN)

(21) Appl. No.: 15/374,987

(22) Filed: Dec. 9, 2016

(30) Foreign Application Priority Data
Dec. 31, 2015 (CN) 201511031049.4

(51) Int. Cl. G06F 3/01

(52) U.S. Cl. CPC G06F 3/013

(57) ABSTRACT

Electronic device and method for displaying focal region via display unit for control. A control method detects one or more user eye-focused positions on a display unit of an electronic device; determines a focal region on the display unit based on the one or more detected user eye-focused positions; and displays the focal region on the display unit, where the displayed focal region encompasses the one or more detected user eye-focused positions on the display unit, and provides a user with control of the electronic device via the display unit. An electronic device includes a processor; a display unit coupled to the processor; and an eye-tracking unit coupled to the processor, where the processor is configured to control the display unit to display a focal region that encompasses one or more user eye-focused positions on the display unit as detected by the eye-tracking unit and provides a user with control via the display unit.

### CROSS-REFERENCE TO RELATED APPLICATION

This application claims the benefit of priority to Chinese Patent Application No. 201511031049.4, filed Dec. 31, 2015, the entire contents of which are incorporated herein by reference.

### TECHNICAL FIELD

The present invention relates to the field of information technologies, and in particular, relates to an information processing method and an electronic device.

### BACKGROUND

With the development of information technology and electronic technology, the method of eye behavior interaction has been conceived, which involves an eye tracker and the like. During the process of eye movement detection, a focal point to which the eye is directed is detected, and the detected focal point is displayed on a display unit, enabling a user to determine whether to select a desired interactive object or interactive information via eye movement. Finally an electronic device performs according to the selected interactive object or information.

During the specific implementation process, users may frequently find that the displayed focal point is jittery, and a slightly extended eye movement would result in a large movement of the displayed focal point on the display unit, which affects the users' viewing comfort. Thus, the present application seeks to address the existing prior art problem.

### SUMMARY

Embodiments of the invention provide an improved methodology for control of an electronic device via a display unit.

According to one illustrative embodiment, a control method is provided, comprising: detecting one or more user eye-focused positions on a display unit of an electronic device; determining a focal region on the display unit based on the one or more detected user eye-focused positions; and displaying the focal region on the display unit, wherein the displayed focal region encompasses the one or more detected user eye-focused positions on the display unit, and provides a user with control of the electronic device via the display unit.

According to another illustrative embodiment, a control method is provided, comprising: displaying a focal region with respect to a user eye-focused position on a display unit of an electronic device, the focal region being for providing a user with control of the electronic device via the display unit; detecting one or more user eye-focused positions on the display unit with respect to the displayed focal region; and adjusting a parameter of the displayed focal region based on the one or more detected eye-focused positions.

According to yet another illustrative embodiment, an electronic device is provided, comprising: a processor; a display unit coupled to the processor; and an eye-tracking unit coupled to the processor, wherein the processor is configured to control the display unit to display a focal region that encompasses one or more user eye-focused positions on the display unit as detected by the eye-tracking unit and provides a user with control via the display unit.

### BRIEF DESCRIPTION OF THE DRAWINGS

FIG. 1 is a flow diagram of a first information processing method according to an embodiment;

FIG. 2 shows a focal region and eye movement focal points according to an embodiment;

FIG. 3 is a flow diagram of a second information processing method according to an embodiment;

FIG. 4 shows another focal region and eye movement focal points according to an embodiment;

FIG. 5 shows another focal region and eye movement focal points according to an embodiment;

FIG. 6 is a schematic diagram of an electronic device according to an embodiment; and

FIG. 7 is a flow diagram of a third information processing method according to an embodiment.

### DETAILED DESCRIPTION

### Embodiment 1

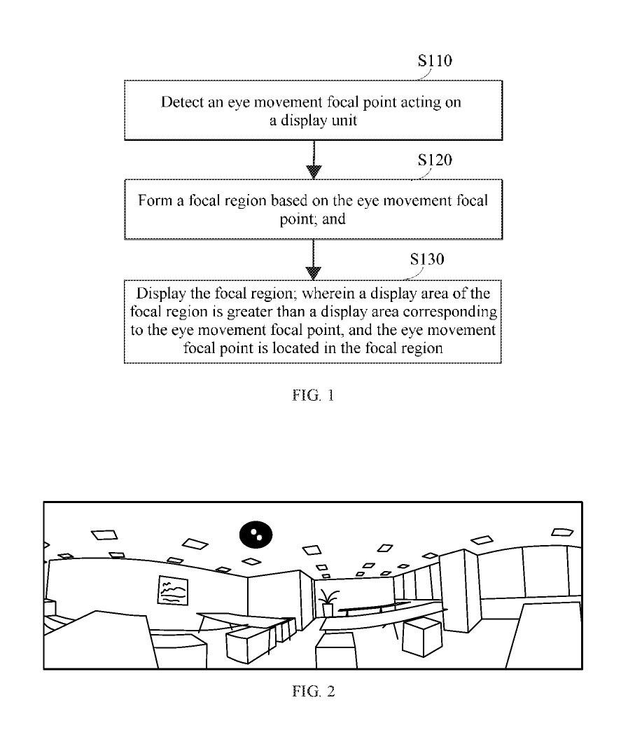

As illustrated in FIG. 1, this embodiment provides an information processing method, wherein the method comprises the following steps:
step S110: detecting an eye movement focal point acting on a display unit;
step S120: forming a focal region based on the eye movement focal point; and
step S130: displaying the focal region; wherein a display area of the focal region is greater than a display area corresponding to the eye movement focal point, and the eye movement focal point is located in the focal region.

The information processing method described in this embodiment may be applied to various electronic devices having a display unit, such as an electronic display screen, a desktop computer, a projector device and the like.

An aligned focal point after the user's eye moves may be collected by using various methods such as image collection or receiving the collected image in step S110. For example, an eye tracker may be used to detect the eye movement focal point.

A focal region is formed based on the eye movement focal point in step S120, and the focal region is displayed in S130. The display area of the focal region is greater than a display region corresponding to one eye movement focal point. For example, the display area of the eye movement focal point on the display unit is A, and the area of the focal region is B, B being greater than A.

For example, as illustrated in FIG. 2, a black circular region is the focal region, and a white dot region in the black circular region is the eye movement focal point. It is apparent that the display area of the black circular region corresponding to the focal region is greater than the area of the white dot region corresponding to the eye movement focal point.

In this case, if a slight movement of the user's eye results in the eye movement focal point slightly shifting, or due to precision issues, a device for detecting the eye movement focal point detects that the eye movement focal point generates a position offset in a state where the user's eye does not move, and if the display area of eye movement focal point acting on the display unit is still located in the display region corresponding to the focal region, it can be seen that the focal region does not shift, or the shifted distance of the focal region is less than the diameter of the focal region. This addresses the problem in the prior art where an image of the eye movement focal point frequently jitters, which occurs when an image corresponding to the eye movement focal point is directly displayed.

In this embodiment, the focal region may be a circular region as illustrated in FIG. 2, or may be in other regional shapes, such as a rectangular region, an elliptical region, or other irregular block regions.

Nevertheless, the detection precision of some eye movement devices is low, possibly causing noise to frequently appear in the areas around the eye movement focal point. If the method in this embodiment is used to form the focal region, it can be seen that the phenomenon where the image of the eye movement focal point shifts or frequently jitters, caused by a noise phenomenon, may be solved; simultaneously displayed is the focal region corresponding to the eye movement focal point, which is convenient for the user to view the focal region displayed on the display unit, and effectively reduces visual fatigue and enhances user satisfaction.

### Embodiment 2

As illustrated in FIG. 1, this embodiment provides an information processing method, wherein the method comprises the following steps:
step S110: detecting an eye movement focal point acting on a display unit;
step S120: forming a focal region based on the eye movement focal point; and
step S130: displaying the focal region; wherein a display area of the focal region is greater than a display area corresponding to the eye movement focal point, and the eye movement focal point is located in the focal region.

Step S110 may comprise:
detecting N eye movement focal points acting on the display unit within a first specified period of time, wherein N is no less than 2.

The first specified period of time described in this embodiment may be a preset time, and may correspond to a preset duration, such as 0.01s or 0.1s. In this way, continuous monitoring of the eye movement focal point within the first specified period of time may detect a plurality of eye movement focal points acting on the display unit. The focal region is determined according to the N eye movement focal points in step S120, such that the precision of positioning is enhanced. In this embodiment, the detecting device detects that both a time for forming one eye movement focal point and an implementation interval are less than the first specified period of time. Generally, the duration for detecting that one eye movement focal point is formed is a first duration, and the duration corresponding to the first specified period of time is at least twice or more than twice the duration of the first duration.

For example, the user desires to make the eye movement focal point to be aligned with an icon on the display unit, due to the small eye movement focal point in the prior art, slight movement of the user may result in the shifting of the eye movement focal point. It is apparent that, during the alignment process, a case may appear where after the eye movement focal point is aligned with the icon, then leaves the icon, and finally the user modifies the position to which the eyes are directed, the eye movement focal point returns to the icon. In the prior art, the user may see that the eye movement focal point makes a large-scale movement and position change on the display unit, but using the method described in this embodiment, the displayed focal region determined by the eye movement focal point within the first specified period of time may well solve the problem caused by the above phenomenon. In this embodiment, the focal region is determined according to the eye movement focal point within the first specified period of time. It may be considered that the first specified period of time is a changed minimum time unit in the focal region. If the movement of the user's eye results a drift in the eye movement, or an eye movement detection device, such as an eye tracker, causes that the eye movement focal point to move, in this embodiment, such movements may all be considered as normal movements within the first specified period of time, and the display unit does not immediately make a response to the movement of the eye movement focal point and further moves the eye movement focal point. A focal region with a relative large display area may be generated in this embodiment. The undesired phenomenon caused by the slight movement of the user's eye and the inaccurateness of the detection device is decreased by moving the focal region or maintaining immovability of the focal region, reducing visual fatigue and enhancing user satisfaction.

Using FIG. 2 as an example, the white dot eye movement focal point as illustrated in FIG. 2 is detected within the first specified period of time, and an image of the eye movement focal point is directly displayed according to the prior art, such that a case may appear where the eye movement focal point moves from the position of one white dot to the position of the other white dot. In this way, it can be seen that a problem may appear where the image of the eye movement focal point frequently moves, and users are easily prone to visual fatigue. However, the detected eye movement focal point in this embodiment may form a focal region, and the focal region covers the eye movement focal point, such that frequent movement of the image of the eye movement focal point will not happen, or discontinuous frequent jittering will not appear, thus the problem of visual fatigue may be at least partially relieved.

### Embodiment 3

As illustrated in FIG. 1, this embodiment provides an information processing method, wherein the method comprises the following steps:
step S110: detecting an eye movement focal point acting on a display unit;
step S120: forming a focal region based on the eye movement focal point; and
step S130: displaying the focal region; wherein a display area of the focal region is greater than a display area corresponding to the eye movement focal point, and the eye movement focal point is located in the focal region.

Step S110 may comprise:
detecting N eye movement focal points acting on the display unit within a first specified period of time, wherein N is no less than 2.

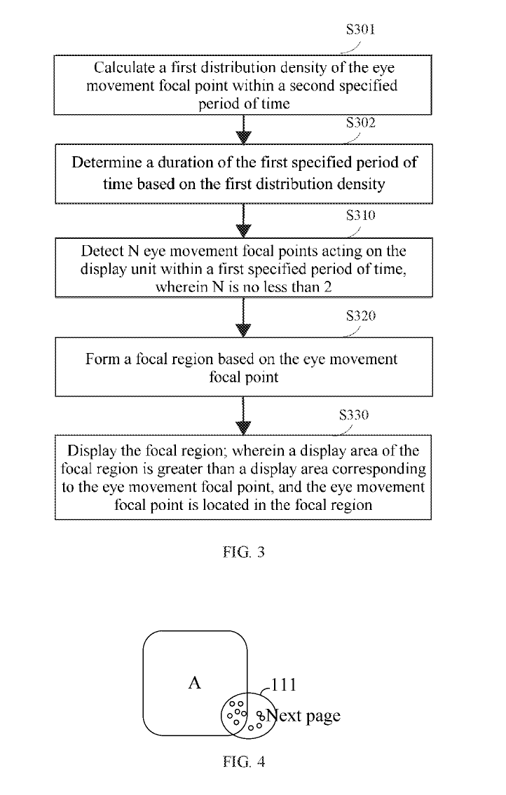

As illustrated in FIG. 3, the method further comprises the following steps:
step S301: calculating a first distribution density of the eye movement focal point within a second specified period of time; and
step S302: determining a duration of the first specified period of time based on the first distribution density.

In this embodiment, the distribution density of the eye movement focal point within the second specified period of time is detected, and the distribution density herein shall be referred to as the first distribution density. In this embodiment, the stop time of the second specified period of time is no later than the stop time of the first specified period of time. The duration of the second specified period of time may be longer than the duration of the first specified period of time, or may be shorter than the duration of the first specified period of time. For example, within the second specified period of time and before determining the first specified period of time, by means of calculating the distribution density of the eye movement focal point, the first distribution density is acquired, and the duration of the first specified period of time of the focal region is determined based on the first distribution density. Nevertheless, the second specified period of time may also be a period of time whose duration is no longer than the duration corresponding to the first specified period of time within the range of the first specified period of time. The first specified period of time may at least comprise one or more second specified periods of time, and the distribution density within each of the second specified periods of time is calculated to obtain the first distribution density. Once the calculated first distribution density is greater than a predetermined value, it is determined that the first specified period of time ends. In this way, each of the first specified periods of time may be dynamically determined.

In conclusion, in this embodiment, the distribution density of the eye movement focal point within the second specified period of time is great, and is probable that the detection precision of the current detection device is high or the slight movement of user's eye is small. At this moment, in order to improve a response rate, the duration of the first specified period of time in this embodiment will be adjusted. Nevertheless, the precision of the detection device may fluctuate, and the movement speed of the user's eye may also fluctuate. In this embodiment, the duration of the first specified period of time will be dynamically determined, such that a relationship between the visual fatigue of the user and the response speed will be well balanced.

To be specific, step S302 may comprise:
decreasing a duration of the first specified period of time if the first distribution density is greater than a first density threshold; or
maintaining or increasing a duration of the first specified period of time if the first distribution density is less than the first density threshold.

The first density threshold may be a predetermined value, and through comparison and judgment, the duration of the first specified period of time is suitably adjusted. Herein, the adjustment of the duration of the first specified period of time may be adjusted according to a preset step value, or the adjusted value of the step may be dynamically determined according to a functional relationship satisfied by the first distribution density and the first distribution density threshold. For example, a ratio of the first distribution density and the first distribution density threshold is solved, and a reciprocal of the ratio and a product of the duration of the first specified period of time are used as the duration of the first specified period of time after the adjustment.

In this embodiment, when the first distribution density is greater than the first density threshold, it is considered that the distribution of current eye movement focal points is relatively centralized, and the response speed may be improved by decreasing the duration of the first specified period of time. When the first distribution density is less than the first density threshold, it is meant that the currently detected eye movement focal points are dispersed. To reduce the frequent jittering of the eye movement focal points and relieve the user of visual fatigue, in this embodiment, the duration of the first specified period of time may be suitably increased. Nevertheless, to ensure the desired response speed, in this embodiment, an upper threshold may be defined for the duration of the first specified period of time. If currently the duration of first specified period of time has reached the upper threshold, the duration of the first specified period of time may be maintained unchanged in this embodiment.

In conclusion, according to the information processing method in this embodiment, a focal region is formed according to the eye movement focal point, and the phenomenon where the image of the eye movement focal point unnecessarily jitters due to insufficient precision of the detection device, misoperations caused by slight movements of the user, or interference caused by noise is simply solved by displaying the focal region. In addition, according to the method in this embodiment, the duration of the first specified period of time may be dynamically adjusted according to the distribution density of the eye movement focal point, and the response speed is ensured to some extent.

### Embodiment 4

As illustrated in FIG. 1, this embodiment provides an information processing method, wherein the method comprises the following steps:
step S110: detecting an eye movement focal point acting on a display unit;
step S120: forming a focal region based on the eye movement focal point; and
step S130: displaying the focal region; wherein a display area of the focal region is greater than a display area corresponding to the eye movement focal point, and the eye movement focal point is located in the focal region.

Step S110 may comprise:
detecting N eye movement focal points acting on the display unit within a first specified period of time, wherein N is no less than 2;
displaying at least one interactive object on the display unit; and
the method further comprises:
calculating a second distribution density corresponding to the focal region within the first specified period of time; and
determining, based on the second distribution density, an interactive object effected by the focal region.

In this embodiment, the interactive object may comprise various interactive icons or interactive texts having the interaction function. The interactive object herein may comprise an application icon, a file document, a link, “OK” or “Cancel” function buttons and the like displayed on the display unit. Generally, some interactive operations may be performed with the electronic device by applying a corresponding operation on the icon or text, such as clicking. For example, a corresponding application may be opened by clicking the corresponding application icon. The application icon herein is one of the interactive objects, and the opening of the corresponding application refers to detecting an operation specified by the user's instruction for an electronic device.

In this embodiment, within the first specified period of time, a plurality of eye movement focal points are detected, wherein these eye movement focal points are proximal to each other or distal from each other. In this embodiment, the focal region covers at least a portion of the detected plurality of eye movement focal points. In this embodiment, a distribution density of the eye movement focal points is covered by the focal region, wherein the distribution density in this embodiment is referred to as the second distribution density, and the interactive object effected by the focal region is determined based on the distribution density. For example, as illustrated in FIG. 4, the display unit displays two interactive objects at adjacent positions, which are respectively an application icon A and a page-turn link for “Next Page”. Reference numeral 111 denotes the focal region described in the present application, and it is obvious that in this case the focal region covers the two interaction objects. In this embodiment, the second distribution density of the eye movement focal points covering the two interactive objects is calculated, and in FIG. 2, the white dot denotes the eye movement focal point. By means of calculation, it is found that the second distribution density of the eye movement focal points at the application icon A in the focal region is greater than that of the region covered by the page-turn link for “Next Page”. In this case, it may be determined that the focal region is smaller than the application icon A. Nevertheless, the example herein is only applicable to the selection process of a single interactive object by using the focal region, and is not applicable to all the above described embodiments illustrating determining the interactive object acting on the focal region according to the second distribution density.

Nevertheless, in this embodiment, determining the interactive object acting on the focal region according to the second distribution density may further comprise: considering that the focal region acts on the interactive object when the second distribution density is greater than a predetermined density threshold. For example, when the display unit has a plurality of interactive objects, the user's eye is always tracking to find his or her desired interactive object; when the time exceeds the duration of the first specified period of time, a focal region may also be formed. However, the electronic device finds that the second distribution density in the focal region is small, considers that the user has no intention to select an interactive object, and thus would not select an interactive object covered by the focal region. When the second distribution density is greater than the predetermined density threshold, one or more interactive objects covered by the focal region are at least selected.

In conclusion, in this embodiment, the interactive object effected by the focal region is determined according to the second distribution density, such that the electronic device more precisely make a response to the user's instruction.

### Embodiment 5

As illustrated in FIG. 1, this embodiment provides an information processing method, wherein the method comprises the following steps:
step S110: detecting an eye movement focal point acting on a display unit;
step S120: forming a focal region based on the eye movement focal point; and
step S130: displaying the focal region; wherein a display area of the focal region is greater than a display area corresponding to the eye movement focal point, and the eye movement focal point is located in the focal region.

The method further comprises:
calculating a third distribution density of the eye movement focal point within a third specified period of time; and
determining a display area of the focal region within a fourth specified period of time based on the third distribution density;
wherein the fourth specified period of time is later than the third specified period of time.

In this embodiment, the duration of the third specified period of time may be 1 minute, 2 minutes, 5 minutes, 30 seconds or any predetermined duration. The distribution density of the eye movement focal point may to some extent characterize a velocity or amplitude parameter of the eye movement, or may characterize information such as the detection precision of a detection device; and the display area of the focal region is adjusted according to the third distribution density. Adjusting the display area herein may comprise various adjustments, such as increasing the display area, decreasing the display area and the like.

The fourth specified period of time may be a period of time after the third specified period of time, for example, a period of time after the current time. The fourth specified period of time may be a period of time corresponding to a predetermined duration, or may be a period of time which can be flexibly adjusted. For example, the period between the time after the display area is determined and before the time when a new display area corresponding to the focal region is not received may be considered to be the fourth specified period of time. In this case, it is obvious that the duration of the fourth specified period of time and the corresponding time period are both determined by the generation time of two different display areas.

In conclusion, based on the above described embodiments, this embodiment provides a method for dynamically adjusting the display area of the focal region according to the third distribution density, which is capable of preventing the phenomenon where positioning of the interactive object is not precise because the display area of the focal region is too large.

The determining a display area of the focal region within a fourth specified period of time based on the third distribution density comprises:
decreasing the display area of the focal region if the third distribution density is greater than a second density threshold; or
maintaining or increasing the display area of the focal region if the third distribution density is less than the second density threshold.

In this embodiment, according to the method for processing information, the second density threshold may be prestored, or the second density threshold may be received or queried from another electronic device; and it is determined, by performing comparison or the like processing between the third distribution density and the second density threshold, to decrease the display area of the focal region or maintain the display area of the focal region or increase the display area of the focal region.

For example, to prevent the phenomenon where positioning of the focal region is not precise because the focal region is too large, in this embodiment, an upper threshold may be defined for the display area of the focal region. If the current display area of the focal region has reached the upper threshold, even if the third distribution density is less than the second density threshold, the display area of the focal region is not increased, and only the current display area of the focal region is maintained.

In conclusion, this embodiment not only provides a solution of adjusting the display area of the focal region based on the third distribution density, but also provides a solution of specifically adjusting the display area of the focal region, which is simple in implementation and is capable of dynamically adjusting the display area to reach a balance between visual feeling of the user and the positioning precision.

### Embodiment 6

As illustrated in FIG. 1, this embodiment provides an information processing method, wherein the method comprises the following steps:
step S110: detecting an eye movement focal point acting on a display unit;
step S120: forming a focal region based on the eye movement focal point; and
step S130: displaying the focal region; wherein a display area of the focal region is greater than a display area corresponding to the eye movement focal point, and the eye movement focal point is located in the focal region.

Step S120 comprises:
calculating a fourth distribution density of the eye movement focal point acting on the display unit in each first region within a fifth specified period of time; and
selecting the first region with the maximum fourth distribution density as a central region of the focal region;
wherein a display area of the first region is not larger than the display area of the focal region, and the focal region comprises the first region.

The fifth specified period of time may be a predetermined period of time, or may be a period of time determined by the electronic device according to the distribution density of the previous eye movement focal points. This embodiment is a further improvement of the technical solution according to any of the above described embodiments.

Within the fifth specified period of time, N eye movement focal points may partially overlap, or may be distributed at different positions. In this embodiment, a region of the eye movement focal point acting on the display unit may be divided into a plurality of first regions, wherein the first region may be a plurality of regions having the same display area. The distribution density of the eye movement focal point in each of the first regions is calculated, such that the display position of the focal region on the display unit is determined. In this embodiment, one first region having the greatest distribution density is used as a central region of the focal region, and the display area of the first region is less than the focal region. In this way, the display position of the focal region on the display unit is simply determined.

Based on the above described embodiments, this embodiment provides a method for determining the display position of a focal region, which has the advantages of simple implementation, precise determination of the display region to which the user's eye is directed, and high positioning precision.

### Embodiment 7

As illustrated in FIG. 6, this embodiment provides an electronic device, wherein the electronic device comprises:
a detecting unit 110, configured to detect an eye movement focal point acting on a display unit;
a forming unit 120, configured to form a focal region based on the eye movement focal point; and
a display unit 130, configured to display the focal region; wherein a display area of the focal region is greater than a display area corresponding to the eye movement focal point, and the eye movement focal point is located in the focal region.

The electronic device in this embodiment may comprise a laptop computer, a desktop computer, an electronic reader, an electronic display screen and the like.

The detecting unit 110 may comprise various collecting device or sensors capable of collecting eye movements, for example, a camera for collecting the eye movement focal point by using a device, such as an image, an eye tracker and the like.

The forming unit 120 corresponds to a processor or a processing circuit in an electronic device, wherein the processor may comprise an application processor, a central processor, a microprocessor, a digital signal processing or programmable array and the like. The processing circuit may comprise a dedicated integrated circuit. The processor or the processing circuit may generate the focal region by executing the corresponding code.

The display unit 130 may correspond to various display screens, for example, a liquid crystal display (LCD) screen, an organic light-emitting diode (OLED) display screen, a projector display screen, an electronic ink display screen and the like display devices, which are capable of displaying an image and/or text, and may be configured to display the focal region in this embodiment.

In this embodiment, after an eye movement focal point is detected, the eye movement focal point is not directly displayed. Instead, an eye movement region is formed, wherein the display area of the eye movement region is greater than the region corresponding to the eye movement focal point. In this embodiment, the electronic device forms an eye movement region by using the forming unit 120, and displays the eye movement region by using the display unit 130. This reduces the phenomena of visual fatigue because the eye movement focal point seen by the user frequently shifts due to direct display of the eye movement focal point and noise is caused to the eye movement focal point due to insufficient precision and poor stability of the detection device, and enhances electronic device intelligence and user satisfaction.

### Embodiment 8

As illustrated in FIG. 6, this embodiment provides an electronic device, wherein the electronic device comprises:
a detecting unit 110, configured to detect an eye movement focal point acting on a display unit;
a forming unit 120, configured to form a focal region based on the eye movement focal point; and
a display unit 130, configured to display the focal region; wherein a display area of the focal region is greater than a display area corresponding to the eye movement focal point, and the eye movement focal point is located in the focal region.

The detecting unit 110 is specifically configured to detect N eye movement focal points acting on the display unit within a first specified period of time, wherein N is no less than 2.

In this embodiment, the detecting unit 110 detects at least two eye movement focal points acting on the display unit within the first specified period of time. It is obvious that the time elapsed each time the detecting unit 110 herein detects the eye movement focal point is less than the first specified period of time. The forming unit 120 specifically generates the focal region according to the N eye movement focal points. In this embodiment, one focal region is determined via multiple detections by using the detecting unit 110. In this way, the precision of positioning the displayed content on the display unit to which the user's eye is directed, according to the eye movement of the user, is obviously improved.

### Embodiment 9

As illustrated in FIG. 6, this embodiment provides an electronic device, wherein the electronic device comprises:
a detecting unit 110, configured to detect an eye movement focal point acting on a display unit;
a forming unit 120, configured to form a focal region based on the eye movement focal point; and
a display unit 130, configured to display the focal region; wherein a display area of the focal region is greater than a display area corresponding to the eye movement focal point, and the eye movement focal point is located in the focal region.

The detecting unit 110 is specifically configured to detect N eye movement focal points acting on the display unit within a first specified period of time, wherein N is no less than 2.

The electronic device further comprises:
a first calculating unit, configured to calculate a first distribution density of the eye movement focal point within a second specified period of time; and
a first determining unit, configured to determine duration of the first specified period of time based on the first distribution density.

In this embodiment, the first calculating unit may comprise a timer, a counter, a calculator and the like structure, and meanwhile comprise a processor, a processing circuit and the like structure having the timing, counting and calculation functions. The timer may be configured to time the second specified period of time. The counter is configured to count the eye movement focal points at various positions within the second specified period of time. The calculator is configured to calculate the second distribution density of the eye movement focal points at various positions.

The first determining unit may correspond to a processor or a processing circuit in the electronic device. The details of the processor or the processing circuit herein may be referenced to the above described embodiments. The duration of the first specified period of time is adjusted according to the first distribution density, such that the response speed, the positioning precision and the user's visual feeling are balanced, and the desired precision and user's visual feeling are ensured as far as possible while ensuring a high response speed.

As a further improvement of this embodiment, the first determining unit is configured to decrease a duration of the first specified period of time if the first distribution density is greater than a first density threshold; or maintain or increase a duration of the first specified period of time if the first distribution density is less than the first density threshold.

In this embodiment, the first determining unit may comprise a comparator or a processor having the comparison function. For example, the comparator compares the first distribution density with the first density threshold. Nevertheless, the first determining unit may further comprise a processor or a processing circuit, wherein the processor or the processing circuit may decrease the duration of the first specified period of time according to a comparison result between the first distribution density and the first density threshold; hence, determining to maintain or increase the duration of the first specified period of time. In addition, based on the electronic device provided in the above described technical solution, this embodiment further provides an optional structure of the electronic device for adjusting the duration of the first specified period of time, which has the advantages of simple structure and simple implementation.

### Embodiment 10

As illustrated in FIG. 6, this embodiment provides an electronic device, wherein the electronic device comprises:
a detecting unit 110, configured to detect an eye movement focal point acting on a display unit;
a forming unit 120, configured to form a focal region based on the eye movement focal point; and
a display unit 130, configured to display the focal region; wherein a display area of the focal region is greater than a display area corresponding to the eye movement focal point, and the eye movement focal point is located in the focal region.

At least one interactive object is displayed on the display unit 130.

The electronic device further comprises:
a second calculating unit, configured to calculate a second distribution density corresponding to the focal region within the first specified period of time; and
a second determining unit, configured to determine an interactive object effected by the focal region based on the second distribution density.

In this embodiment, the interactive object may comprise various objects, displayed by the display unit, capable of interacting information, for example, an image interactive object, a text interactive object and the like.

In this embodiment, the hardware structure of the second calculating unit is similar to the hardware structure of the first calculating unit in the above described embodiment, and the hardware structure of the second determining unit is also similar to the hardware structure of the first determining unit in the above described embodiment. The difference lies in the distribution density of the eye movement focal points in the focal region within the first specified period of time calculated by the second calculating unit, wherein the distribution density in this embodiment is referred to as the second distribution density. In this embodiment, the second determining unit determines the interactive object effected by the focal region according to the second distribution density. For example, in this embodiment, it is determined according to the second distribution density of the focal region whether an interactive object is selected and which interactive object is selected. In this embodiment, the electronic device determines the interactive object according to the second distribution density, which, as compared with the determination of the interactive object according to a single eye movement focal point, improves the precision of positioning the interactive object based on the eye movement.

### Embodiment 11

As illustrated in FIG. 6, this embodiment provides an electronic device, wherein the electronic device comprises:
a detecting unit 110, configured to detect an eye movement focal point acting on a display unit;
a forming unit 120, configured to form a focal region based on the eye movement focal point; and
a display unit 130, configured to display the focal region; wherein a display area of the focal region is greater than a display area corresponding to the eye movement focal point, and the eye movement focal point is located in the focal region.

The electronic device further comprises:
a third calculating unit, configured to calculate a third distribution density of the eye movement focal point within a third specified period of time; and
a third determining unit, configured to determine a display area of the focal region within a fourth specified period of time based on the third distribution density;
wherein the fourth specified period of time is later than the third specified period of time.

In this embodiment, the hardware structure of the third calculating unit may be referenced to the first calculating unit or the second calculating unit in the above described embodiments. Likewise, the third calculating unit may comprise a timer, a counter, a calculator or the like structure, to determine the third distribution density within the third specified period of time. Herein, the hardware structure of the third determining unit is also similar to that of the first determining unit or the second determining unit. In this embodiment, the display area of the focal region is dynamically adjusted according to the third distribution density within the third specified period of time. In this way, the positioning precision of the focal region and the user's visual feeling are balanced.

As a further improvement of this embodiment, the third determining unit is configured to decrease the display area of the focal region if the third distribution density is greater than a second density threshold; or maintain or increase the display area of the focal region if the third distribution density is less than the second density threshold.

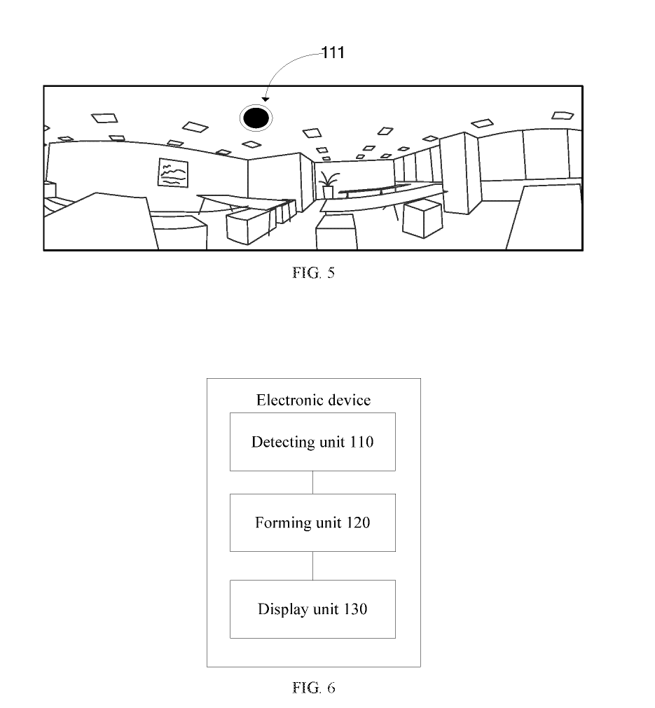

As illustrated in FIG. 5, the display area of the focal region 111 displayed on the display unit is expanded from the region denoted by the black solid dot to the region denoted by the circle with a white background and outlined in black. It is obvious that the display area of the focal region 111 is increased.

In this embodiment, the third determining unit may correspond to a comparator or a comparator circuit or a processor or processing circuit having the comparison function, and may determine whether to decrease the display area of the focal region, or maintain the display area of the focal region unchanged or increase the display area of the focal region by comparing the third distribution density with the second density threshold. The electronic device according to this embodiment dynamically adjusts the display area of the focal region according to the third distribution density within the third specified period of time, which has the advantages of simple structure and simple implementation.

### Embodiment 12

As illustrated in FIG. 6, this embodiment provides an electronic device, wherein the electronic device comprises:
a detecting unit 110, configured to detect an eye movement focal point acting on a display unit;
a forming unit 120, configured to form a focal region based on the eye movement focal point; and
a display unit 130, configured to display the focal region; wherein a display area of the focal region is greater than a display area corresponding to the eye movement focal point, and the eye movement focal point is located in the focal region.

The forming unit 120 is specifically configured to calculate a fourth distribution density of the eye movement focal point acting on the display unit in each first region within a fifth specified period of time; select the first region with the maximum fourth distribution density as a central region of the focal region; and a display area of the first region is not larger than the display area of the focal region, and the focal region comprises the first region.

The specific structure of the forming unit 120 in this embodiment may be referenced to the above described embodiments. In this embodiment, the forming unit 120 may determine the display area of the focal region, and may further determine the display position of the focal region. In this embodiment, the display range covered by the focal region detected within the fifth specified period of time may be divided into a plurality of first regions, wherein the display area of the first region herein is less than the display area of the focal region; then the distribution density of the eye movement focal point of each first region is calculated, and one first region having the greatest distribution density is selected as a central region of the focal region in this embodiment. In this way, the display area of the focal region may be simply determined, which has the advantages of simple structure and simple implementation.

A specific example is provided hereinafter with reference to any of the above described embodiments.

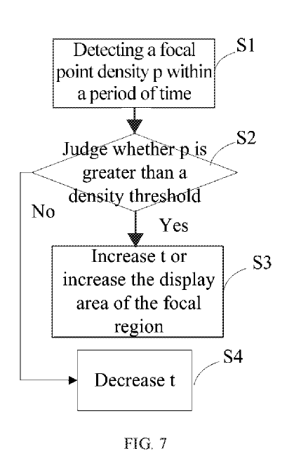

As illustrated in FIG. 7, this embodiment provides an information processing method, wherein the method comprises the following steps:
step S1: detecting a focal point density p within a period of time t, wherein the focal point density corresponds to the distribution density in the above described embodiments;
step S2: judging whether p is greater than a density threshold, and if greater, entering step S3, and otherwise, entering step S4; wherein the density threshold corresponds to the distribution density in the above described embodiments;
step S3: increasing t or increasing the area of the focal region; and
step S4: decreasing t; nevertheless, in practical implementation, step S4 may further comprise decreasing the area of the focal region.

In the several embodiments provided in the present invention, it should be understood that the disclosed device and method may be practiced in other manners. The above described device embodiments are merely illustrative. For example, the unit division is merely a method of logical function division and may be other methods of division in actual practice. For example, multiple units or components may be combined or integrated into another system, or some features can be ignored or not performed. In addition, the displayed or discussed mutual couplings or direct couplings or communication connections of the various constitutional parts are practiced through some interfaces. The indirect couplings or communication connections between the devices or units may be practiced in electronic, mechanical or other forms.

The units used as separate components may be or may not be physically independent of each other. The element illustrated as a unit may be or may not be a physical unit, that is be either located at a position or deployed on a plurality of network units. A part or all of the units may be selected according to the actual needs to achieve the objectives of the solutions of the embodiments.

In addition, the functional units in the various embodiments of the present invention may be integrated in one processing unit, or may separately and physically exist as a single unit, or two or more units may be integrated in one unit. The integrated unit may be practiced through hardware, or may also be practiced in a form of hardware plus a software functional unit.

Persons of ordinary skill in the art may understand that all or part of the steps according to the embodiments of the present invention may be executed by a program instructing related hardware. The programs may be stored in a computer readable storage medium. When the programs are executed, the steps of the method in the embodiment are executed. The storage medium includes various media capable of storing program code, such as a mobile storage device, a read-only memory (ROM), a random access memory (RAM), a magnetic disk, or optical disk and the like.

The above embodiments are used only for illustrating the present invention, and are not intended to limit the protection scope of the present invention. Various modifications and replacements readily derived by those skilled in the art within technical disclosure of the present invention shall fall within the protection scope of the present invention. Therefore, the protection scope of the present invention is subject to the claims.

What is claimed is:

1. A control method, comprising:
detecting one or more user eye-focused positions on a display unit of an electronic device;
determining a focal region on the display unit based on the detected one or more user eye-focused positions; and
displaying the focal region on the display unit,
wherein the displayed focal region encompasses the one or more detected user eye-focused positions on the display unit, and provides a user with control of the electronic device via the display unit.

2. The control method of claim 1, wherein the step of displaying the focal region on the display unit further comprises:
detecting one or more further user eye-focused positions with respect to the displayed focal region on the display unit; and
adjusting a parameter of the displayed focal region based on the detected one or more further user eye-focused positions.

3. The control method of claim 2, wherein the step of detecting the one or more further user eye-focused positions comprises:
determining a distribution density of said detected one or more further eye-focused positions; and
comparing the determined distribution density against a distribution density threshold.

4. The control method of claim 3, wherein the step of adjusting the parameter of the displayed focal region comprises increasing an area of the displayed focal region, in response to the determined distribution density being smaller than the distribution density threshold.

5. The control method of claim 3, wherein the step of detecting the one or more further user eye-focused positions further comprises detecting the one or more further user eye-focused positions within a predetermined time period for determining control of the electronic device.

6. The control method of claim 5, wherein the step of adjusting the parameter of the displayed focal region comprises increasing said predetermined time period, in response to the determined distribution density being smaller than the distribution density threshold.

7. The control method of claim 5, wherein the step of adjusting the parameter of the displayed focal region comprises reducing said predetermined time period, in response to the determined distribution density being greater than the distribution density threshold.

8. A control method, comprising:
displaying a focal region with respect to a user eye-focused position on a display unit of an electronic device, the focal region being for providing a user with control of the electronic device via the display unit;
detecting one or more user eye-focused positions on the display unit with respect to the displayed focal region; and
adjusting a parameter of the displayed focal region based on the detected one or more eye-focused positions.

9. The control method of claim 8, wherein the step of detecting the one or more user eye-focused positions comprises:
determining a distribution density of the detected one or more user eye-focused positions; and
comparing the determined distribution density against a distribution density threshold.

10. The control method of claim 9, wherein the step of adjusting the parameter of the displayed focal region comprises increasing an area of the displayed focal region, in response to the determined distribution density being smaller than the distribution density threshold.

11. The control method of claim 9, wherein the step of detecting the one or more user eye-focused positions further comprises detecting the one or more user eye-focused positions within a predetermined time period.

12. The control method of claim 11, wherein the step of adjusting the parameter of the displayed focal region comprises increasing said predetermined time period, in response to the determined distribution density being smaller than the distribution density threshold.

13. The control method of claim 11, wherein the step of adjusting the parameter of the displayed focal region comprises reducing said predetermined time period, in response to the determined distribution density being greater than the distribution density threshold.

14. An electronic device, comprising:
a processor;
a display unit coupled to the processor; and
an eye-tracking unit coupled to the processor,
wherein the processor is configured to control the display unit to display a focal region that encompasses one or more user eye-focused positions on the display unit as detected by the eye-tracking unit and provides a user with control via the display unit.

15. The electronic device of claim 14, wherein the processor is further configured to adjust a parameter of the displayed focal region based on one or more further user eye-focused positions as detected by the eye-tracking unit.

16. The electronic device of claim 15, wherein the processor is further configured to:
determine a distribution density of said one or more further eye-focused positions as detected by the eye-tracking unit; and
compare the determined distribution density against a distribution density threshold.

17. The electronic device of claim 16, wherein the processor is further configured to increase an area of the focal region as displayed on the display unit, in response to the determined distribution density being smaller than the distribution density threshold.

18. The electronic device of claim 16, wherein the eye-tracking unit is configured to detect the one or more further user eye-focused positions within a predetermined time period for determining control via the display unit.

19. The electronic device of claim 18, wherein the processor is further configured to increase said predetermined time period, in response to the determined distribution density being smaller than the distribution density threshold.

20. The electronic device of claim 18, wherein the processor is further configured to reduce said predetermined time period, in response to the determined distribution density being greater than the distribution density threshold.
